(19) United States
(12) Patent Application Publication
(10) Pub. No.: US 2021/0064997 A1
(43) Pub. Date: Mar. 4, 2021

(54) METHOD FOR GPU MEMORY MANAGEMENT FOR DEEP NEURAL NETWORK AND COMPUTING DEVICE FOR PERFORMING SAME

(71) Applicant: SEOUL NATIONAL UNIVERSITY R&DB FOUNDATION, Seoul (KR)

(72) Inventors: Jaejin LEE, Seoul (KR); Jungho PARK, Seoul (KR)

(73) Assignee: SEOUL NATIONAL UNIVERSITY R&DB FOUNDATION, Seoul (KR)

(21) Appl. No.: 16/961,073

(22) PCT Filed: Nov. 29, 2018
(86) PCT No.: PCT/KR2018/014894

§ 371 Date: Jul. 9, 2020

(30) Foreign Application Priority Data
Jan. 10, 2018 (KR) 10-2018-0003587

(51) Int. Cl. G06N 3/08; G06T 1/20; G06F 9/50

(52) U.S. Cl. CPC G06N 3/08; G06F 9/5038; G06F 9/5016; G06T 1/20

(57) ABSTRACT

Embodiments disclosed herein relate to a method for GPU memory management that observes the deep learning of a deep neural network performed by a GPU and reduces the amount of GPU memory used, thereby overcoming limitations attributable to the memory size of the GPU and allowing the more effective performance of the deep learning, and a computing device for performing the same. According to an embodiment, there is disclosed a method for GPU memory management for a deep neural network, the method being performed by a computing device including a GPU and a CPU, the method including: generating a schedule for GPU memory management based on the processing of a unit operation, included in the deep neural network, by the GPU; and moving data required for deep learning of the deep neural network between GPU memory and CPU memory based on the schedule.

### TECHNICAL FIELD

Embodiments disclosed herein relate to a method for GPU memory management for a deep neural network and a computing device for performing the same, and particularly to a method for GPU memory management that observes the deep learning of a deep neural network performed by a GPU and reduces the amount of GPU memory used, thereby overcoming a limitation attributable to the memory size of the GPU and allowing deep learning to be more effectively performed, and a computing device for performing the same.

Year 2018 Project Number and Acknowledgements

1. Project serial No.: 1711073574

2. Korean acknowledgement: “ [symbol] [symbol] 2018 [symbol] [symbol] [symbol] [symbol] [symbol] [symbol] [symbol] (No. 1711073574, FPGA [symbol] CUDA [symbol] [symbol] [symbol] [symbol] [symbol] (2016M3C4A7952587, PF [symbol] [symbol] [symbol] [symbol] [symbol] [symbol] .”

3. English acknowledgement: “This work was supported by Institute for Information & communications Technology Promotion (IITP) grant funded by the Ministry of Science and ICT (MSIT) (No. 1711073574, CUDA Programming Environment for FPGA Clusters), the National Research Foundation of Korea funded by the MSIT (No. 2016M3C4A7952587, PF Class Heterogeneous High Performance Computer Development).”

### BACKGROUND ART

Deep learning collectively refers to a number of ways to create and learn a large number of layers in an artificial neural network. Although research into artificial neural networks has been conducted for a long period, they were not put into practical use until the mid-2000s due to their massive computational load. In particular, when deep learning using a deep neural network (DNN) is performed using a GPU, a difficulty arises in that the limitation of the capacity of GPU occurs.

In connection to this, Korean Patent No. 10-17667875, which is a prior art document, discloses a technology for deep learning based on a GPU, and particularly an ‘image correction method using deep learning analysis based on a GPU device.’ However, even with the above-described conventional technology, there are still insufficient aspects regarding technology for overcoming the limitation of the capacity of the GPU memory.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### DISCLOSURE

### Technical Problem

Embodiments disclosed herein are intended to disclose a method for GPU memory management that can overcome the limitation of the capacity of GPU memory, and a computing device for performing the same.

Furthermore, embodiments are intended to overcome the limitation of GPU memory by utilizing CPU memory when a GPU performs deep learning using a deep neural network.

Furthermore, embodiments are intended to generate an effective schedule that moves data required for the deep learning of a deep neural network between GPU memory and CPU memory according to the operation processing pattern of a GPU based on the characteristic in which an operation for each layer is repeatedly performed in the deep learning of the deep neural network. In this case, the embodiments are intended to minimize the time by which an operation is delayed due to the movement of data by overlapping the movement of data between the GPU memory and the CPU memory and the operation processing of the GPU.

Furthermore, embodiments are intended to overcome the limitation of GPU memory by dividing the input data of a deep neural network and reducing a batch size processed by a GPU at one time.

Moreover, embodiments are intended to secure the transparency of use by performing a method for GPU memory management without the need to modify or recompile the source code of the framework of the conventional deep neural network.

### Technical Solution

As a technical solution for solving the above-described technical problems, according to an embodiment, there is disclosed a method for GPU memory management for a deep neural network, the method being performed by a computing device including a GPU and a CPU, the method including: generating a schedule for GPU memory management based on the processing of a unit operation, included in the deep neural network, by the GPU; and moving data required for deep learning of the deep neural network between GPU memory and CPU memory based on the schedule.

According to another embodiment, there is disclosed a computer-readable storage medium having stored therein a program that performs a method for GPU memory management. In this case, the method for GPU memory management is performed by a computing device, and may include: generating a schedule for GPU memory management based on the processing of a unit operation, included in a deep neural network, by a GPU; and moving data required for deep learning of the deep neural network between GPU memory and CPU memory based on the schedule.

According to still another embodiment, there is disclosed a computer program that is executed by a computing device and stored in a medium to perform a method for GPU memory management. In this case, the method for GPU memory management is performed by a computing device, and may include: generating a schedule for GPU memory management based on the processing of a unit operation, included in a deep neural network, by a GPU; and moving data required for deep learning of the deep neural network between GPU memory and CPU memory based on the schedule.

According to still another embodiment, there is disclosed a computing device including a computation unit, wherein the computation unit includes a GPU and a CPU, and generates a schedule for GPU memory management based on the processing of a unit operation, included in a deep neural network, by the GPU and moves data required for the deep learning of the deep neural network between GPU memory and CPU memory based on the schedule.

### Advantageous Effects

According to any one of the above-described technical solutions, the embodiments disclosed herein may disclose the method for GPU memory management that can overcome the limitation of the capacity of the GPU memory, and the computing device for performing the same.

Furthermore, the embodiments may overcome the limitation of the GPU memory by utilizing the CPU memory when the GPU performs deep learning using a deep neural network.

Furthermore, the embodiments may generate an effective schedule that moves data required for the deep learning of a deep neural network between the GPU memory and the CPU memory according to the operation processing pattern of the GPU based on the characteristic in which an operation for each layer is repeatedly performed in the deep learning of the deep neural network. In this case, the embodiments may minimize the time by which an operation is delayed due to the movement of data by overlapping the movement of data between the GPU memory and the CPU memory and the operation processing of the GPU.

Furthermore, the embodiments may overcome the limitation of the GPU memory by dividing the input data of a deep neural network and reducing a batch size processed by the GPU at one time.

Moreover, the embodiments may secure the transparency of use by performing the method for GPU memory management without the need to modify or recompile the source code of the framework of the conventional deep neural network.

The effects that can be obtained by the embodiments disclosed herein are not limited to the above-described effects, and other effects that have not been described above will be apparently understood by those having ordinary skill in the art, to which the present invention pertains, from the following description.

### DESCRIPTION OF DRAWINGS

FIGS. 1 and 2 are block diagrams showing the configuration of a computing device according to an embodiment;

FIGS. 3 to 5 are diagrams showing an example of the operation of a computing device according to an embodiment; and

FIGS. 6 to 9 are flowcharts illustrating methods for GPU memory management according to embodiments.

### MODE FOR INVENTION

Various embodiments will be described in detail below with reference to the accompanying drawings. The following embodiments may be modified to and practiced in various different forms. In order to more clearly illustrate the features of the embodiments, detailed descriptions of items that are well known to those having ordinary skill in the art to the following embodiments pertain will be omitted. In the drawings, portions unrelated to the following description will be omitted. Throughout the specification, like reference symbols will be assigned to like portions.

Throughout the specification, when one component is described as being “connected” to another component, this includes not only a case where they are ‘directly connected’ to each other but also a case where they are ‘connected to each other with a third component disposed therebetween.’ Furthermore, when a component is described as ‘including’ another component, this does not mean that the former component excludes another component but means that the former component may further include another component, unless explicitly described to the contrary.

Embodiments will be described in detail below with reference to the accompanying drawings.

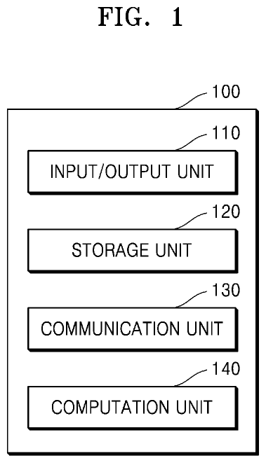

FIG. 1 is a block diagram showing the configuration of a computing device 100 according to an embodiment.

According to the embodiment of the present specification, the computing device 100 includes a graphics processing unit (GPU) for performing deep learning using a deep neural network (DNN), and performs a method for GPU memory management in order to overcome the limitation of GPU memory when the GPU performs deep learning using a deep neural network.

Referring to FIG. 1, the computing device 100 according to the embodiment may include an input/output unit 110, a storage unit 120, a communication unit 130, and a computation unit 140.

The input/output unit 110 according to an embodiment may include an input unit for receiving input from a user, and an output unit for displaying information about the result of the performance of computation, e.g., the result of the performance of deep learning by a deep neural network. For example, the input/output unit 110 may include an operation panel configured to receive input from a user, and a display panel configured to output images.

More specifically, the input unit may include various types of input reception devices such as a keyboard, physical buttons, a touch screen, or a camera. Furthermore, the output unit may include a display panel, a speaker, or a headset. However, the input/output unit 110 is not limited to the above-described examples, but may include configurations configured to support various types of input and output.

Meanwhile, various types of data for the deep learning of a deep neural network may be installed and stored in the storage unit 120. According to an embodiment, the storage unit 120 may store input data, i.e., a target of a deep neural network, intermediate data, and the result data of deep learning, and may store and run software such as an application and/or a device driver for the deep learning of a deep neural network. According to an embodiment, the storage unit 120 may be embedded in at least one of a GPU and a CPU included in the computation unit 140 to be described later.

Meanwhile, the communication unit 130 may perform wired/wireless communication with another device or network. For this purpose, the communication unit 130 may include a communication module configured to support at least one of various wired/wireless communication methods. For example, the communication module may be implemented in the form of a chipset.

The wireless communication supported by the communication unit 130 may be, e.g., wireless fidelity (Wi-Fi), Wi-Fi Direct, Bluetooth, ultra-wide band (UWB), or near field communication (NFC). Furthermore, the wired communication supported by the communication unit 130 may be, e.g., USB or high definition multimedia interface (HDMI).

According to an embodiment, the communication unit 130 may receive input data, which is a target of a deep neural network, from a third server.

Meanwhile, the computation unit 140 may control the overall operation of the computing device 100. According to an embodiment, the computing unit 140 may control other components included in the computing device 100 to perform deep learning using a deep neural network, and may process various types of data to perform deep learning using a deep neural network. In this case, the deep learning may include the learning and inference of a deep neural network.

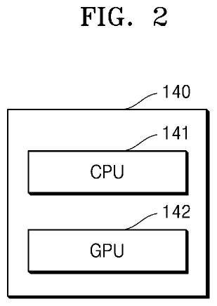

In this case, FIG. 2 is a block diagram illustrating an embodiment of the computation unit 140. Referring to FIG. 2, the computation unit 140 may include processors such as a CPU 141 and a GPU 142. According to an embodiment, each of the CPU 141 and the GPU 142 may include embedded memory. In other words, the CPU 141 may include CPU memory, and the GPU 142 may include GPU memory.

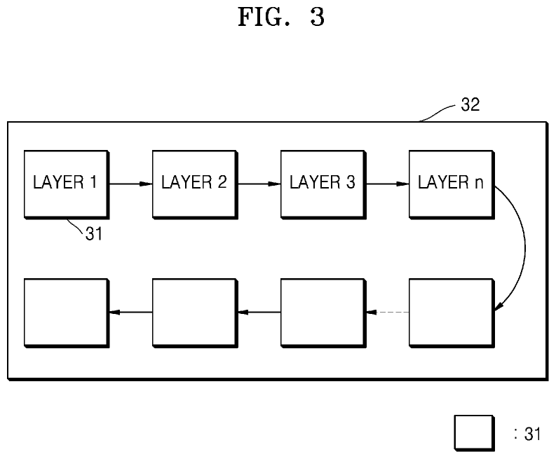

In this case, referring to FIG. 3, FIG. 3 is a view schematically showing an example of the configuration of a deep neural network. Referring to FIG. 3, the deep neural network includes a plurality of layers 31. The deep neural network (DNN) includes all neural networks each having three or more layers, including not only a neural network including fully connected layers (FC layers) but also a convolution neural network (CNN) and a recurrent neural network (RNN). A computation process processed in each layer included in the deep neural network is referred to as a ‘unit operation.’ According to an embodiment, a unit operation may be implemented as a predetermined function, in which case the predetermined function may be implemented as a CUDA kernel or an OpenCL kernel and may be provided in a library form such as cuDNN or cuBlas.

Furthermore, the deep learning of the deep neural network may repeat the process of sequentially performing unit operations corresponding to the plurality of respective layers 31. In this case, a process including the plurality of repeated layers is referred to as an ‘iteration 32.’ In other words, the deep learning of the deep neural network may include the process of repeating a unit operation corresponding to each of the plurality of layers 31 by repeating the iteration 32 including the plurality of layers 31 a plurality of times.

In this case, according to an embodiment, the above-described deep learning using a deep neural network may be performed by the GPU 142. In other words, the GPU 142 may perform the deep learning using a deep neural network by repeating an iteration adapted to sequentially perform a plurality of unit operations.

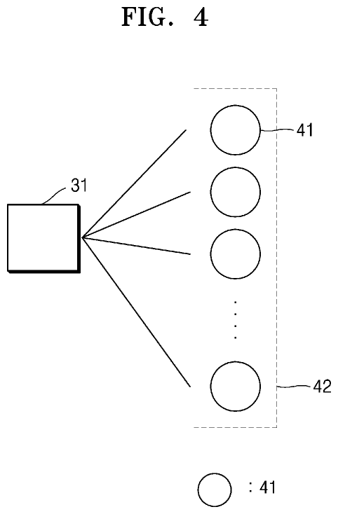

In this case, referring to FIG. 4, FIG. 4 is a diagram schematically illustrating an example of the relationship between a unit operation and ‘required data 41,’ i.e., information required for the performance of the unit operation. Referring to FIG. 4, each unit operation may match one or more pieces of required data 41. Furthermore, a data unit including one or more pieces of required data 41 corresponding to one unit operation is referred to as a ‘required data bundle 42.’ According to an embodiment, the required data 41 may include input data, a weight value used in each layer, and an intermediate result (a feature map) output in each layer.

Meanwhile, the GPU 142 may receive the required data 41 or required data bundle 42 before or during each unit operation via the GPU memory when performing the unit operation. Furthermore, the GPU 142 may perform deep learning using a deep neural network by performing the unit operation based on the required data 41 received by the GPU memory. In this case, the performance of the GPU 142 achieved when the GPU 142 performs deep learning using a deep neural network may be dependent upon the management of the GPU memory.

In the conventional deep learning using a deep neural network, the deep learning is performed to process required data with all required data corresponding to all unit operations input to GPU memory. In this case, when the size of the GPU memory is smaller than the overall size of all the required data, deep learning cannot be performed.

Accordingly, according to an embodiment, the computation unit 140 attempts to perform deep learning using a deep neural network requiring a large amount of memory with minimal performance degradation by performing a method for GPU memory management. In connection with this, the method for GPU memory management performed by the computation unit 140 will be described in detail below. The method for GPU memory management described below may be controlled by the CPU 141 included in the computation unit 140 or by the GPU 142 according to an embodiment.

According to an embodiment, the computation unit 140 may move data required for the deep learning of a deep neural network between the GPU memory and the CPU memory in order to effectively utilize the GPU memory. For example, the computation unit 140 may move required data from the CPU memory to the GPU memory or from the GPU memory to the CPU memory. In this case, the term ‘swap in’ means to move the required data to be processed from the CPU memory to the GPU memory, and the term ‘swap in’ means to move the required data to be processed from the GPU memory to the CPU memory.

Meanwhile, the computation unit 140 may generate a GPU memory management schedule for the purpose of managing the GPU memory. According to an embodiment, the computation unit 140 may generate a schedule for GPU memory management, and, more specifically, may generate a schedule based on the processing of unit operations included in the deep neural network of the GPU 142.

As described above, the GPU 142 may sequentially perform one or more unit operations by repeating an iteration including the one or more unit operations, and may also repeatedly perform the unit operations.

In this case, the computation unit 140 may generate a schedule based on the repeated processing of unit operations corresponding to the set number of times, and may apply the generated schedule to the repeated processing of the unit operations after the set number of times. In other words, the computation unit 140 may generate a schedule based on information about the processing of unit operations acquired based on the processing of the unit operations in the initial stage of an iteration when the unit operations are repeated a plurality of times. Furthermore, the computation unit 140 may apply the generated schedule to the unit operations to be repeated after the schedule has been generated.

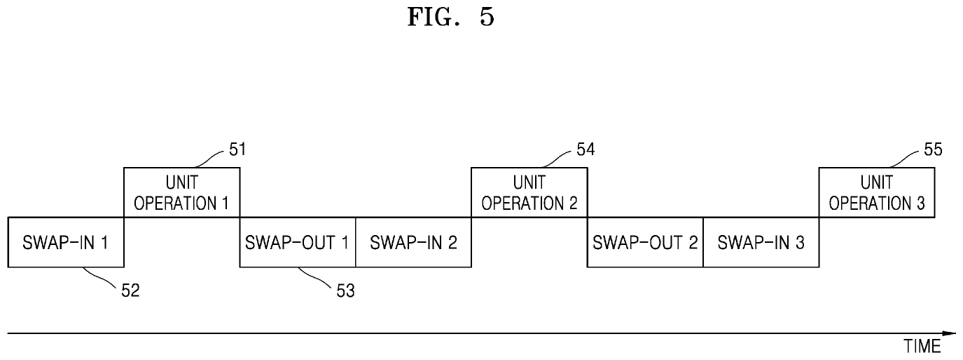

In this case, referring to FIG. 5, FIG. 5 is a diagram schematically illustrating an example of a process of the initial iteration of unit operations for the generation of a schedule. According to FIG. 5, the computation unit 140 may swap in (see 52) one or more pieces of required data corresponding to a unit operation before performing a unit operation 51. For example, the computation unit 140 may collectively swap in (see 52) one or more pieces of required data corresponding to the unit operation 51.

Furthermore, the computation unit 140 may hook a call occurring as the unit operation 51 proceeds based on the swapped-in (see 52) required data. In this case, the computation unit 140 may acquire unit operation processing information based on the call, and may generate a schedule for each piece of required data based on the acquired unit operation processing information.

Furthermore, when the unit operation 51 is completed, the computation unit 140 may swap out (see 53) the processed required data. For example, the computation unit 140 may perform the unit operation 51 based on the swapped-in (see 51) required data, and, then, may collectively swap out (see 53) the processed one or more pieces of required data.

Furthermore, the computation unit 140 may sequentially perform subsequent operations 54 and 55 after the unit operation according to the performance of the deep learning of a deep neural network. In this case, the computation unit 140 may perform the above-described swap-in and swap-out processes for each of the subsequent operations 54 and 55, and may acquire unit operation processing information corresponding to each of the unit operations.

According to an embodiment, the unit operation processing information may include at least one of information about the performance of a unit operation, information about required data, and information about GPU memory. In this case, the information about the performance of a unit operation unit may include the performance time of the unit operation, the sequential position of the performance of the unit operation, a function corresponding to the unit operation, and information about required data matching the unit operation, e.g., information adapted to specify required data matching the unit operation. Furthermore, the information about required data may include the size of the required data, and the movement time of the required data between the GPU memory and the CPU memory. Furthermore, the information about GPU memory may include the size of the GPU memory.

According to an embodiment, the computation unit 140 may reduce the processing time of the unit operation by performing the swap-in and swap-out of the required data together with the unit operation in an overlapping manner based on the acquired unit operation processing information.

For this purpose, the computation unit 140 may apply the acquired unit operation processing information to linear programming (LP). In this case, the linear programming may include integer linear programming (ILP).

LP is a technique that is used to maximize or minimize a linear objective function while satisfying linear conditions given as a type of optimization problems. For example, when a linear equation is established between variable elements (when variable elements have linear relationships), an inequality may be established using the limit of change, and the value of a variable that minimizes or maximizes a predetermined objective function may be acquired. According to an embodiment, LP may solve problems using a commercial solver.

According to an embodiment, the computation unit 140 may generate an inequality based on ILP to which the acquired unit work processing information is applied, and may derive a schedule minimizing the performance time of the deep learning of a deep neural network by allowing the movement of required data and the operation of deep learning to overlap each other as much as possible.

Meanwhile, according to an embodiment, the computation unit 140 may generate a schedule based on a heuristic technique. In this case, if the time required for a swap-in and a swap-out exceeds the processing time of a unit operation when swapping in one or more pieces of required data corresponding to a unit operation and swapping out required data processed according to a unit operation, the computation unit 140 may search for a swap-in command that can be processed in an operation preceding the unit operation and generate a schedule so that the swap-in command will be processed during the performance of the preceding operation.

According to a more specific embodiment, the computation unit 140 may sequentially perform a plurality of unit operations, may swap in necessary required data during each unit operation, and may swap out processed required data during each unit operation.

In this case, the computation unit 140 may detect an ‘excess unit operation’ in which the time required for a swap-in and a swap-out exceeds the processing time of a unit operation among unit operations, may search for a swap-in command corresponding to the excess unit operation, and may search for an operation that precedes the excess unit operation and can be processed along with the found swap-in command in an overlapping manner. In this case, the operation that precedes the excess unit operation and can be processed along with the found swap-in command corresponding to the excess unit operation in an overlapping manner is referred to as an ‘excess preceding operation.’

According to an embodiment, the computation unit 140 may generate a schedule so that a swap-in command corresponding to an excess unit operation overlaps an excess preceding operation. In this case, the computation unit 140 may search for an excess preceding operation, more particularly an excess preceding operation to be overlapped by the processing time of a swap-in command corresponding to an excess unit operation as much as possible, and may generate a schedule based on the excess preceding operation.

Furthermore, according to an embodiment, when a swap-out command for the same required data is found while searching for an excess preceding operation, the computation unit 140 may prevent unnecessary communication by eliminating a swap-in command and the swap-out command.

According to an embodiment, the computation unit 140 may repeat a unit operation and update a schedule when searching for an excess preceding operation and generating the schedule so that the processing time of a swap-in command is overlapped. In this case, the computation unit 140 may repeat an iteration until there is no change in a schedule any longer, may search for an excess preceding operation, and may apply a generated schedule to subsequent unit operations and repeating an iteration after the generation of the schedule, thereby performing deep learning using a deep neural network.

When the method for GPU memory management based on the heuristic technique and the method for GPU memory management based on LP according to embodiments are compared with each other, LP can derive an optimum value, but requires a longer time to derive an optimum value than the heuristic technique. In contrast, the heuristic technique can derive a value close to an optimum value, not the optimum value, but has an advantage in that it requires a shorter time to derive a result value than LP.

Meanwhile, the computation unit 140 may reduce a batch size to be processed in the GPU 142 at one time by dividing input data for the performance of deep learning using a deep neural network. For example, the computation unit 140 may divide input data including 256 batches into 4 pieces of input data each including 64 batches. In this case, the computation unit 140 may derive result data (an output feature map) by performing deep learning using a deep neural network including unit operations based on each of the divided four pieces of input data.

According to an embodiment, the computation unit 140 may perform a unit operation, and may swap in required data corresponding to the corresponding unit operation or an operation subsequent to the corresponding unit operation or swap out required data processed in the GPU 142, based on the generated schedule.

According to an embodiment, the above-described method for GPU memory management does not need to modify or recompile the source code of the framework of the conventional deep neural network. For this purpose, the computation unit 140 may perform the above-described method for GPU memory management based on a shared library form. For example, the computation unit may allocate and release the memory of the framework of the deep neural network by performing a swap-in and a swap-out via a shared library, and may hook calls to unit operations in the middle, thereby performing memory management. In addition, calls to commercial libraries, such as cuDNN and cuBlas, the source code of which has not been disclosed may be intercepted to manage memory.

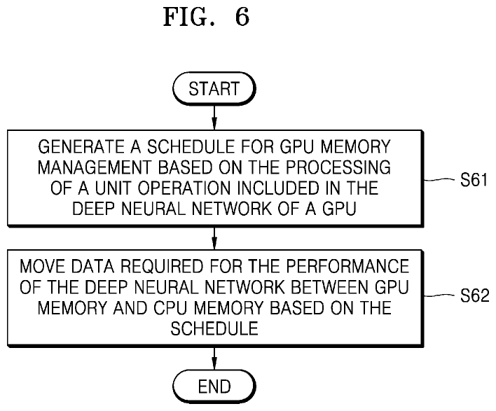

Meanwhile, FIGS. 6 to 9 are flowcharts illustrating a method for GPU memory management that is performed by the computing device 100. The methods for GPU memory management according to the embodiments shown in FIGS. 6 to 9 include the steps that are performed in a time-series manner by the computing device 100 according to the embodiments of FIGS. 1 to 5. Accordingly, the descriptions that will be omitted below but have been given above in conjunction with the computing device 100 according to the embodiments of FIGS. 1 to 5 may be also applied to the methods for GPU memory management according to the embodiments shown in FIGS. 6 to 9.

Referring to FIG. 6, the computing device 100 may generate a schedule for GPU memory management based on the processing of a unit operation included in the deep neural network of the GPU 142 at step S61.

Furthermore, the computing device 100 may move required data necessary for the performance of the deep learning of a deep neural network between the GPU memory and the CPU memory based on the schedule at step S62. In this case, at step S62, the computing device 100 may perform a unit operation, and may swap in required data corresponding to the unit operation or an operation subsequent to the unit operation from the CPU memory to the GPU memory or swap out required data processed in the GPU 142 from the GPU memory to the CPU memory, based on the generated schedule.

According to an embodiment, the deep learning of a deep neural network is performed by repeating an iteration including one or more unit operations a plurality of times. According to this feature, the computing device 100 may generate a schedule based on the repeated processing of unit operations corresponding to the number of times set at step S61, and may apply the schedule to the repeated processing of unit operations after the number of times set at step S62.

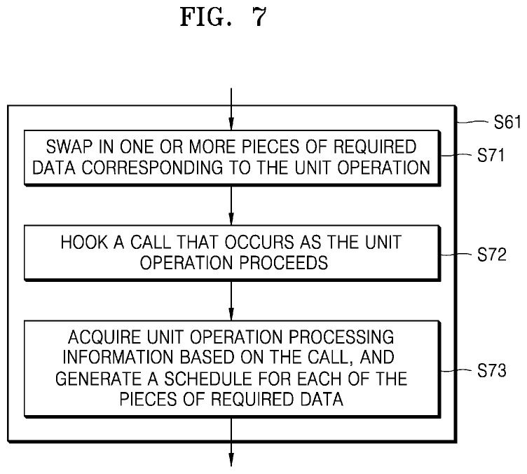

Meanwhile, referring to FIG. 7, the computing device 100 may swap in one or more pieces of required data corresponding to the unit operation at step S71 when generating the schedule at step S61. In this case, the computing device 100 may hook a call occurring as the unit operation proceeds at step S72, and may acquire unit operation processing information based on the call and generate a schedule for each piece of required data at step S73.

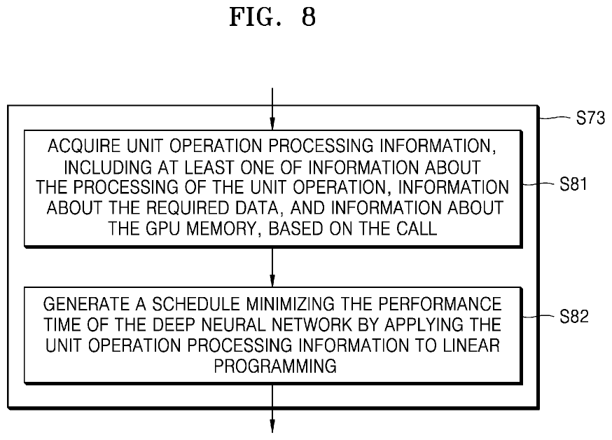

In connection with this, referring to FIG. 8, the computing device 100 may acquire unit operation processing information including at least one of information about the performance of the unit operation, information about the required data, and information about the GPU memory at step S81, and may generate a schedule minimizing the performance time of the deep learning by a deep neural network by applying the acquired unit operation processing information to LP at step S82.

Furthermore, according to an embodiment, if the time required for a swap-in and a swap-out exceeds the processing time of the unit operation when swapping in one or more pieces of required data corresponding to the unit operation and swapping out required data processed according to the unit operation in order to generate the schedule at step S61, the computing device 100 may search for a swap-in command that can be processed in an operation preceding the unit operation and generate a schedule so that the swap-in command can be processed during the performance of the preceding operation.

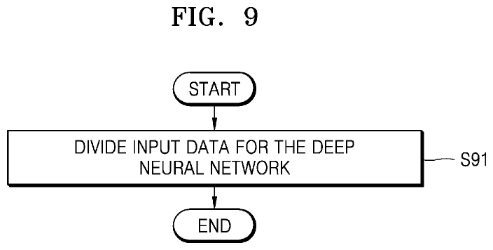

Meanwhile, referring to FIG. 9, the computing device 100 may divide input data for the deep learning of a deep neural network at step S91. According to an embodiment, the computing device 100 may perform a method for GPU memory management after step S61 based on the divided input data.

The term ‘unit’ used in the above-described embodiments means software or a hardware component such as a field-programmable gate array (FPGA) or application-specific integrated circuit (ASIC), and a ‘unit’ performs a specific role. However, a ‘unit’ is not limited to software or hardware. A ‘unit’ may be configured to be present in an addressable storage medium, and also may be configured to run one or more processors. Accordingly, as an example, a ‘unit’ includes components, such as software components, object-oriented software components, class components and task components, processes, functions, attributes, procedures, subroutines, segments in program code, drivers, firmware, microcode, circuits, data, a database, data structures, tables, arrays, and variables.

Each of the functions provided in components and ‘unit(s)’ may be coupled to a smaller number of components and ‘unit(s)’ or divided into a larger number of components and ‘unit(s).’

In addition, components and ‘unit(s)’ may be implemented to run one or more CPUs in a device or secure multimedia card.

Each of the methods for GPU memory management according to the embodiments described with reference to FIGS. 6 to 9 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, each of the methods for GPU memory management according to the embodiments described with reference to FIGS. 6 to 9 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, each of the methods for GPU memory management according to the embodiments described with reference to FIGS. 6 to 9 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued via the present specification should be defined by the attached claims, rather than the detailed description. All modifications and variations which can be derived from the meanings, scopes and equivalents of the claims should be construed as falling within the scope of the present invention.

1. A method for GPU memory management for a deep neural network, the method being performed by a computing device including a GPU and a CPU, the method comprising:
generating a schedule for GPU memory management based on processing of a unit operation, included in the deep neural network, by the GPU; and
moving data required for deep learning of the deep neural network between GPU memory and CPU memory based on the schedule.

2. The method of claim 1, wherein moving the data comprises:
performing the unit operation, and swapping in required data corresponding to at least one of the unit operation and an operation subsequent to the unit operation from the CPU memory to the GPU memory or swapping out required data processed in the GPU from the GPU memory to the CPU memory, based on the schedule.

3. The method of claim 1, wherein:
generating the schedule comprises generating the schedule based on repeated processing of the unit operation corresponding to a set number of times; and
moving the data comprises applying the schedule to repeated processing of the unit operation after the set number of times.

4. The method of claim 1, wherein generating the schedule comprises:
swapping in one or more pieces of required data corresponding to the unit operation;
hooking a call that occurs as processing of the unit operation proceeds; and
acquiring information about the processing of the unit operation based on the call, and generating a schedule for each of the pieces of required data.

5. The method of claim 4, wherein generating the schedule for each of the pieces of required data comprises:
obtaining the unit operation processing information, including at least one of information about performance of the unit operation, information about the required data, and information about the GPU memory, based on the call; and
generating a schedule minimizing a performance time of the deep learning of the deep neural network by applying the unit operation processing information to linear programming.

6. The method of claim 1, wherein generating the schedule comprises:
if a time required for a swap-in and a swap-out exceeds a processing time of the unit operation when swapping in one or more pieces of required data corresponding to the unit operation and swapping out required data processed according to the unit operation, searching for a swap-in command that can be processed in a operation preceding the unit operation, and generating a schedule so that the swap-in command will be processed during performance of the preceding operation.

7. The method of claim 1, further comprising, before generating the schedule, dividing input data for the deep neural network;
wherein generating the schedule is performed on each of pieces of the divided input data.

8. A computer-readable storage medium having stored therein a program that performs the method set forth in claim 1.

9. A computer program that is executed by a computing device and stored in a storage medium to perform the method set forth in claim 1.

10. A computing device comprising a computation unit, wherein the computation unit includes a GPU and a CPU, and generates a schedule for GPU memory management based on processing of a unit operation, included in a deep neural network, by the GPU and moves data required for deep learning of the deep neural network between GPU memory and CPU memory based on the schedule.
